(19) United States
(12) Patent Application Publication
(10) Pub. No.: US 2016/0335630 A1
(43) Pub. Date: Nov. 17, 2016

(54) Method for Providing Secured Card Transactions During Card Not Present (CNP) Transactions

(71) Applicant: Gopesh Kumar, Pleasanton, CA (US)

(72) Inventor: Gopesh Kumar, Pleasanton, CA (US)

(21) Appl. No.: 14/710,334

(22) Filed: May 12, 2015

(51) Int. Cl. G06Q 20/40; G06Q 20/32; G06Q 20/34

(52) U.S. Cl. CPC G06Q 20/405; G06Q 20/34; G06Q 20/4018; G06Q 20/3255; G06Q 20/3276

(57) ABSTRACT

During a card not present (CNP) transaction the user is required to provide more information which includes a two-way handover during transaction processing, merchant options in choosing these steps, security measures in storing information, and retrieving information to fight charge backs. APIs are provided to merchants to integrate with existing transaction processing software the supply sign off option information to the API. Merchants can sign off either prior to or after the transaction processing. Based on the sign off option, the smart phone app displays the steps required to complete the now enhanced sign off process. For the first sign off option, the user must first scan the credit card, then scan a photo id, and then sign the transaction. For the second sign off option, the user has to scan the credit card and sign the transaction. For the third sign off option, the user must sign the transaction.

### CROSS REFERENCE TO RELATED APPLICATIONS

This application is related to U.S. patent application Ser. No. XX/XXX,XXX, entitled “TITLE”, filed on DATE.

### TECHNICAL FIELD OF THE INVENTION

The present invention relates to techniques for managing, supporting and empowering merchants in fighting frauds that are due to Card Not Present(CNP) situations. The present invention method and solution introduces additional security steps during the transaction processing that will force the user to provide more information which will help in reducing the fraudulent transactions and/or to fight charge backs.

### BACKGROUND OF THE INVENTION

A card not present transaction (CNP, MO/TO, Mail Order/Telephone Order, MOTOEC) is a payment card transaction made where the cardholder does not or can not physically present the card for a merchant's visual examination at the time that an order is given and payment processed, such as for mail-order transactions by mail or fax, or over the telephone or Internet. Card not present transactions are a major route for credit card fraud, because it is difficult for a merchant to verify that the actual cardholder is indeed authorizing a purchase.

If a fraudulent CNP transaction is reported, the acquiring bank hosting the merchant account that received the money from the fraudulent transaction must make restitution; whereas with a swiped (card present) transaction, the issuer of the card is liable for restitution. Because of the greater risk, some card issuers charge a greater transaction fee to merchants who routinely handle card not present transactions.

Card-not-present (CNP) merchants must take extra precaution against fraud exposure and associated losses. Anonymous scam artists bet on the fact that many fraud prevention features do not apply in this environment. When processing a cardholder-not-present (CNP) transaction, businesses are encouraged to obtain important information from the card owner such as an card number, the cardholder name as it appears on the card (if applicable), the expiration date of the card (month, year) as it appears on the card, the billing address, the shipping address, or the CVV2 code (if applicable).

To combat this problem, merchants and banks have developed a number of fraud solutions. The card security code system has been set up to reduce the incidence of credit card fraud arising from CNP, as have special card verification features from VISA and MASTERCARD, but it is insufficient to combat todays sophisticated scam artists. Some merchants may build their own by back-end, hard code rules within an e-commerce solution or, a merchant may hire a vendor that specializes in this type of online protection. Fraud mitigation applications can include dynamic rule writing, velocity running, the use of performance scorecards, data management, rules and lists management and maintenance, reconciliation performance and third-party data source connections. While it is important for companies to have online fraud protection, developing these safeguards or outsourcing them can translate into the misdirection of time and resources, which would be better spend on their business.

Consequently, there is a need for a new method for providing authentication and verification services when processing a cardholder-not-present (CNP) transactions that provides a cost effective solution.

### Definitions

Unless stated to the contrary, for the purposes of the present disclosure, the following terms shall have the following definitions:

The term “app” is a shortening of the term “application software”. It has become very popular and in 2010 was listed as “Word of the Year” by the American Dialect Society

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API”: In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other. A good API makes it easier to develop a program by providing all the building blocks. A programmer then puts the blocks together. In addition to accessing databases or computer hardware, such as hard disk drives or video cards, an API can ease the work of programming GUI components. For example, an API can facilitate integration of new features into existing applications (a so-called “plug-in API”). An API can also assist otherwise distinct applications with sharing data, which can help to integrate and enhance the functionalities of the applications. APIs often come in the form of a library that includes specifications for routines, data structures, object classes, and variables. In other cases, notably SOAP and REST services, an API is simply a specification of remote calls exposed to the API consumers. An API specification can take many forms, including an International Standard, such as POSIX, vendor documentation, such as the Microsoft Windows API, or the libraries of a programming language, e.g., Standard Template Library in C++ or Java API.

“API Toolkit”: A toolkit is an assembly of tools; set of basic building units for user interfaces. An “API Toolkit” is therefore a set of basic building units for creating an application programming interface (API).

Address Verification Service (AVS): Allows card-not-present merchants to check a cardholder's billing address with the card Issuer. The merchant includes an AVS request as part of the authorization and receives a result code indicating whether the address given by the cardholder matches the address on file with the Issuer.

An “agent” is person who is helping the user to place the order and/or to process payment over the phone or through online chat or through email.

Browser: a software program that runs on a client host and is used to request Pages and other data from server hosts. This data can be downloaded to the client's disk or displayed on the screen by the browser.

Card: a card can be a credit card or a debit card.

A card not present transaction (CNP, MO/TO, Mail Order/Telephone Order, MOTOEC) is a payment card transaction made where the cardholder does not or can not physically present the card for a merchant's visual examination at the time that an order is given and payment processed, such as for mail-order transactions by mail or fax, or over the telephone or Internet.

“CNP Verification” is the process of providing additional tools such as CNP fraud prevention tools provided by VISA and MASTERCARD for obtaining additional or secondary verification information to ensure that the user of the card is the owner of the card in a card not present (CNP) transaction

Chat: real-time, synchronous, text-based communication via computer or mobile device.

Card Verification Value 2 (CVV2) is a three-digit number imprinted on the signature panel of some credit cards to help card-not-present merchants verify that the customer has a legitimate card in hand at the time of the order. The merchant asks the customer for the CVV2 code and then sends it to the card Issuer as part of the authorization request. The card Issuer checks the CVV2 code to determine its validity, then sends a CVV2 result back to the merchant along with the authorization. CVV2 is a 3 digit number on VISA, MASTERCARD and DISCOVER branded credit and debit cards. On AMERICAN EXPRESS branded credit or debit card it is a 4 digit numeric code. CVV2 numbers are also known as CSC numbers (“Card Security Code”), as well as CVV numbers (“Card Verification Value”). To protect CVV2 data from being compromised, typically operating regulations prohibit merchants from keeping or storing CVV2 numbers once a transaction has been completed.

Client host: a computer that requests Pages from server hosts, and generally communicates through a browser program.

Content provider: a person responsible for providing the information that makes up a collection of Pages.

Electronic notification: any automated communication received by e-mail, phone, fax, text message, SMS, RSS or any third party software notification or alerting system.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

Embedded client software programs: software programs that comprise part of a Web site and that get downloaded into, and executed by, the browser.

EMV stands for EUROPAY, MASTERCARD, and VISA, is a global standard for inter-operation of integrated circuit cards (IC cards or “chip cards”) and IC card capable point of sale (POS) terminals and automated teller machines (ATMs), for authenticating credit and debit card transactions.

“GUI”: In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

Host: a computer that is connected to a network such as the Internet. Every host has a hostname (e.g., mypc.mycompany.com) and a numeric IP address (e.g., 123.104.35.12).

HTML (HyperText Markup Language): the language used to author Pages. In its raw form, HTML looks like normal text, interspersed with formatting commands. A browser's primary function is to read and render HTML.

HTTP (HyperText Transfer Protocol): protocol used between a browser and a Web server to exchange Pages and other data over the Internet.

HyperText: text annotated with links to other Pages (e.g., HTML).

Internet-Based Icon: a graphical or text icon that is linked to this system's database and enables the initiation of contact between the Advisor and the consumer, which is located anywhere throughout the Internet including but not limited to websites, emails, directory listings, and advertisement banners

IP (Internet Protocol): the communication protocol governing the Internet.

An Internet service provider (ISP) is an organization that provides services for accessing, using, or participating in the Internet.

Server host: a computer on the Internet that hands out Pages through a Web server program.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from where ever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component.

“PCI Compliance Guidelines” The Payment Card Industry Data Security Standard (PCI DSS) is a set of requirements designed to ensure that ALL companies that process, store or transmit credit card information maintain a secure environment. Essentially any merchant that has a Merchant ID (MID). PCI applies to ALL organizations or merchants, regardless of size or number of transactions, that accepts, transmits or stores any cardholder data. Said another way, if any customer of that organization ever pays the merchant directly using a credit card or debit card, then the PCI DSS requirements apply.

“QR Code” is a machine-readable code consisting of an array of black and white squares, typically used for storing URLs or other information for reading by the camera on a smartphone. camera on a smartphone.

“Sign off” to implement the present invention, APIs are provided to merchants to integrate with their existing sign off process with their existing transaction processing. The merchant will supply sign off option information to the API. Merchants can sign off either prior to the transaction processing or after the transaction processing. Sign off options include: a card scan, photo id scan, and sign the transaction; a card scan and sign the transaction; and a just sign the transaction option

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smart phones include all of those plus the features of a touchscreen computer, including web browsing, wideband network radio (e.g. LTE), Wi-Fi, 3rd-party apps, wireless motion sensor and mobile payment.

“Two-Way Handover” occurs during the transmission of information from a desktop/server communicating to/with a smartphone/mobile device and then the smartphone/mobile device, automatically or as a result of action, transferring back information from the smartphone/mobile device and back to the desktop/server.

A “User” is any person using the computer system executing the method of the present invention.

URL (Uniform Resource Locator): the address of a Web component or other data. The URL identifies the protocol used to communicate with the server host, the IP address of the server host, and the location of the requested data on the server host.

A “Verify CNP” app is a computer application running during a transaction that provides additional verification steps and information during a card not present (CNP) transaction to further provide security, reduce fraud, and assist merchants in chargeback proceedings.

A “web application” or “web app” is any application software that runs in a web browser and is created in a browser-supported programming language (such as the combination of JavaScript, HTML and CSS) and relies on a web browser to render the application.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

The “Web pages” are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

Web master: the person in charge of keeping a host server and Web server program running

Web page: multimedia information on a Web site. A Web page is an HTML document comprising other Web components, such as images.

Web server: a software program running on a server host, for handing out Pages.

Web site: a collection of Pages residing on one or multiple server hosts and accessible through the same hostname (such as, for example, www.lucent.com).

### SUMMARY OF THE INVENTION

The present invention teaches a method and solution to the problem of card-not-present (CNP) situations. The present invention introduces “additional security steps” during the transaction processing that will force the user to provide more information which will help in reducing the fraudulent transactions and/or to fight charge backs. The merchants will sign-up for the service of the present invention to provide these “additional security steps” on a need basis during the transaction processing.

The present invention, described herein, teaches these “additional security steps”, which includes a two-way handover during transaction processing, merchant options in choosing these steps, security measures in storing information, and retrieving information to fight charge backs.

To implement the present invention, APIs are provided to merchants to integrate with their existing sign off process with their existing transaction processing. The merchant will supply sign off option information to the API.

Merchants can choose the sign off either prior to the transaction processing or after the transaction processing. Sign off options include: a card scan, photo id scan, and sign the transaction; a card scan and sign the transaction; and a just sign the transaction option.

Based on the sign off option, the smart phone app will display the steps required to complete the now enhanced sign off process. For the first sign off option, the user will have to first scan the credit card, the second step will be to scan the photo id, and the third step will be to sign the transaction. For the second sign off option, the user has to scan the credit card and sign the transaction. For the third sign off option, the user has to just sign the transaction.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the current methodology of attempting to prevent fraud in card not present (CNP) transactions.

FIG. 2 is a flow chart illustrating the standard authorization process.

FIG. 3 is a flow chart illustrating the standard clearing and settlement process.

FIG. 4 is a flow chart illustrating the method steps taught by the present invention for improving the current existing transaction process known in the prior art for a card not present (CNP) transaction.

FIG. 5 is a flow chart illustrating the method of the present invention where the agent is waiting the CNP Verification to process the transaction.

FIG. 6 is a flow chart illustrating the method of the present invention where the User is waiting the CNP Verification to process the transaction.

FIG. 7 is a flow chart illustrating the method of the present invention where the User is waiting the CNP Verification to process the transaction and a QR code is shown on the screen.

FIG. 8 is a flow chart illustrating the method of the present invention where the User is waiting on an SMS reminder to provider verification but the card has already been processed.

FIG. 9 is a flow chart illustrating the method of the present invention where the User is displayed the SMS content immediately while being actively on their smart phone rather than waiting on the content to be sent and displayed.

FIG. 10 is a flow chart illustrating how the method of the present invention handles credit card numbers, names, and CVV codes to ensure security and privacy.

### DETAILED DESCRIPTION OF THE INVENTION

The following description is demonstrative in nature and is not intended to limit the scope of the invention or its application of uses. There are a number of significant design features and improvements incorporated within the invention. The current invention is a method for providing secured credit card transactions during card not present (CNP) transactions.

Card-not-present (CNP) merchants must take extra precaution against fraud exposure and associated losses. Anonymous scam artists bet on the fact that many fraud prevention features do not apply in this environment. In its simplest form Card Not Present (“CNP”) fraud involves the unauthorized use of a credit or debit card number, the security code printed on the card (if required by the merchant) and the cardholder's address details to purchase product or services in a non-face-to-face setting. In many cases, the victims maintain possession of their card and are unaware of the unauthorized activity until notified by a merchant or they review their monthly statements.

Today, most CNP fraud takes place on the Internet although some criminals perpetrate it through call center operations or through the mail. In any case, the merchant never physically inspects the credit card, thus the term “card not present”.

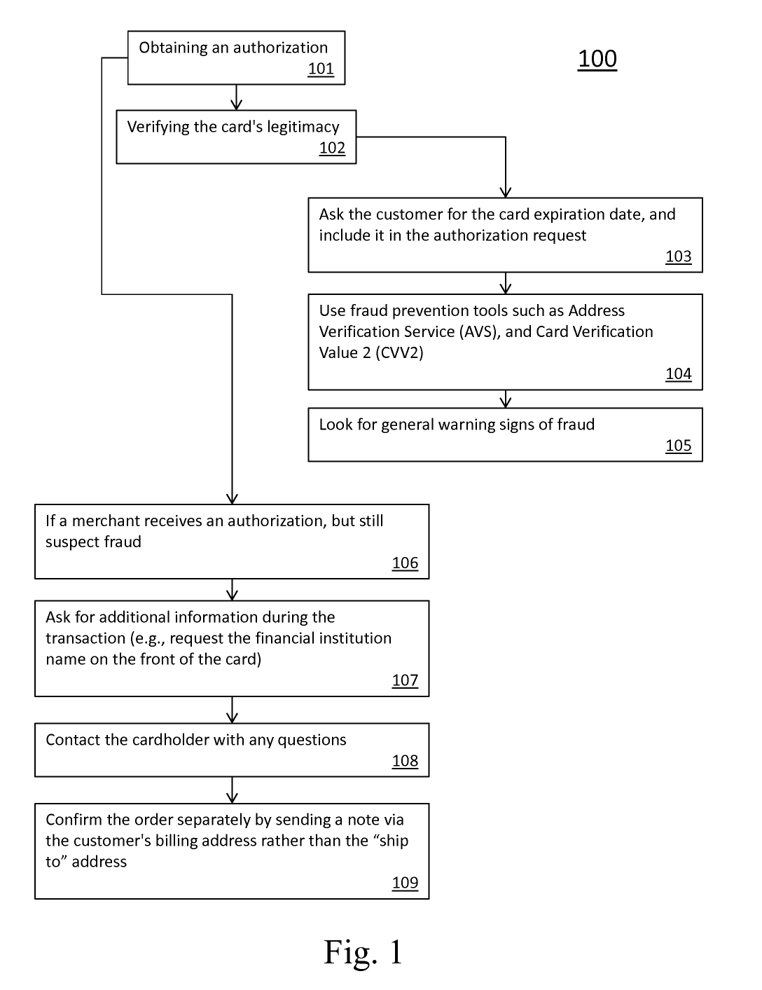

Typical recommendations to help prevent fraud in card-not-present transactions 100 includes the method shown in FIG. 1 comprising the steps of: obtaining an authorization 101, verifying the card's legitimacy 102: Ask the customer for the card expiration date, and include it in the authorization request 103. An invalid or missing expiration date might indicate that the customer does not have the actual card in hand. Use fraud prevention tools such as Address

Verification Service (AVS), and Card Verification Value 2 (CVV2) 104. Look for general warning signs of fraud 105. Finally, if a merchant receives an authorization, but still suspect fraud 106, the merchant should ask for additional information during the transaction (e.g., request the financial institution name on the front of the card) 107, Contact the cardholder with any questions 108, and Confirm the order separately by sending a note via the customer's billing address rather than the “ship to” address 109.

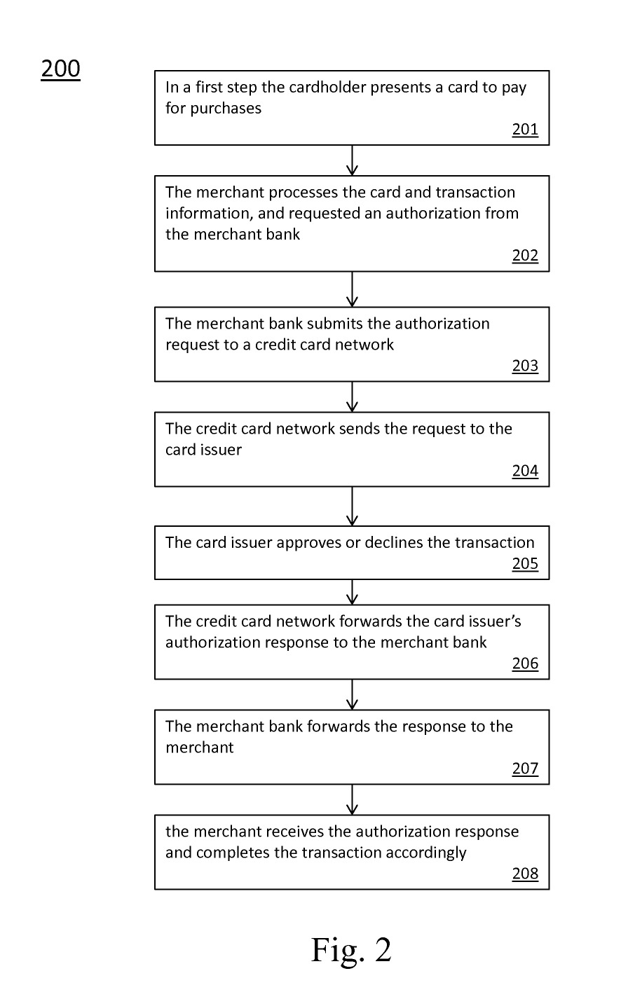

Now referring to FIG. 2, the standard authorization process for card not present (CNP) transactions 200 is illustrated. In a first step the cardholder presents a card to pay for purchases 201. Next, the merchant processes the card and transaction information, and requests an authorization from the merchant bank 202. The merchant bank submits the authorization request to a credit card network 203. The credit card network sends the request to the card issuer 204. The card issuer approves or declines the transaction 205. The credit card network forwards the card issuer's authorization response to the merchant bank 206. The merchant bank forwards the response to the merchant 207. Finally, the merchant receives the authorization response and completes the transaction accordingly 208.

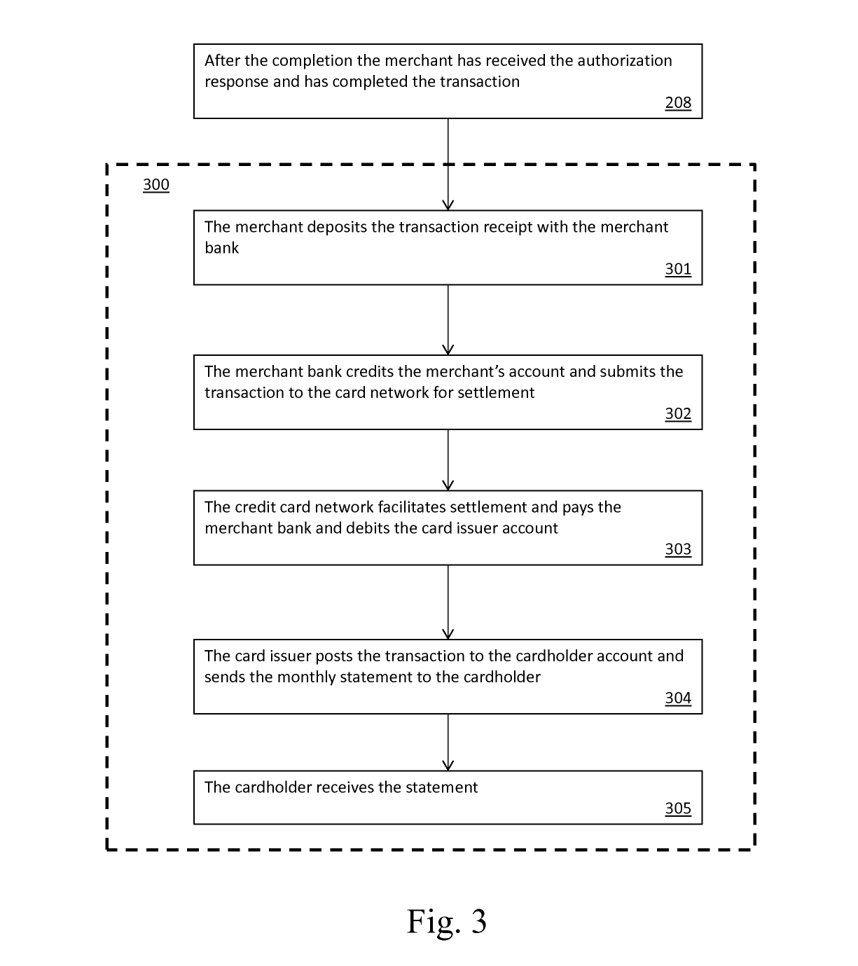

Now referring to FIG. 3, the clearing and settlement process 300 is illustrated after the completion the merchant has received the authorization response and has completed the transaction 208 in the authorization process 200. The merchant deposits the transaction receipt with the merchant bank 301. The merchant bank credits the merchant's account and submits the transaction to the card network for settlement 302. The credit card network facilitates settlement and pays the merchant bank and debits the card issuer account 303. The card issuer posts the transaction to the cardholder account and sends the monthly statement to the cardholder 304. Finally, the cardholder receives the statement 305.

EMV, which stands for Europay, MasterCard, and Visa, is a global standard for inter-operation of integrated circuit cards (IC cards or “chip cards”) and IC card capable point of sale (POS) terminals and automated teller machines (ATMs), for authenticating credit and debit card transactions. The simplest method for circumventing EMV is to use a stolen card number in a place where EMV validation does not occur, such as in an eCommerce transaction.

EMV is designed for instances where a payment instrument is presented in person. Recall from the definition of EMV above that the smart chip in the card or fob or phone must connect with a reader in the POS terminal. The connection can either be physical (i.e., touching) or wireless using near-field communication (NFC) technology over distances of mere inches. As a result, EMV does not address the fraudulent use of payment data when there is no direct connection, such as when the data is entered into an eCommerce application or given over the phone or through the mail—in other words, card-not-present (CNP) situations.

The present invention teaches a method and solution to the problem of card-not-present (CNP) situations. The present invention introduces “additional security steps” during the transaction processing that will force the user to provide more information which will help in reducing the fraudulent transactions and/or to fight charge backs. The merchants will sign-up for the service of the present invention to provide these “additional security steps” on a need basis during the transaction processing.

The present invention, described herein, teaches these “additional security steps”, which includes a two-way handover during transaction processing, merchant options in choosing these steps, security measures in storing information, and retrieving information to fight charge backs. A Two-Way Handover occurs during the transmission of information from a desktop/server communicating to/with a smartphone/mobile device and then the smartphone/mobile device, automatically or as a result of action, transferring back information from the smartphone/mobile device and back to the desktop/server. This process of handing-over and transferring information back and forth between a computer/server and a smartphone/mobile device and vice versa may occur one or more times during the performance of the method of the present invention.

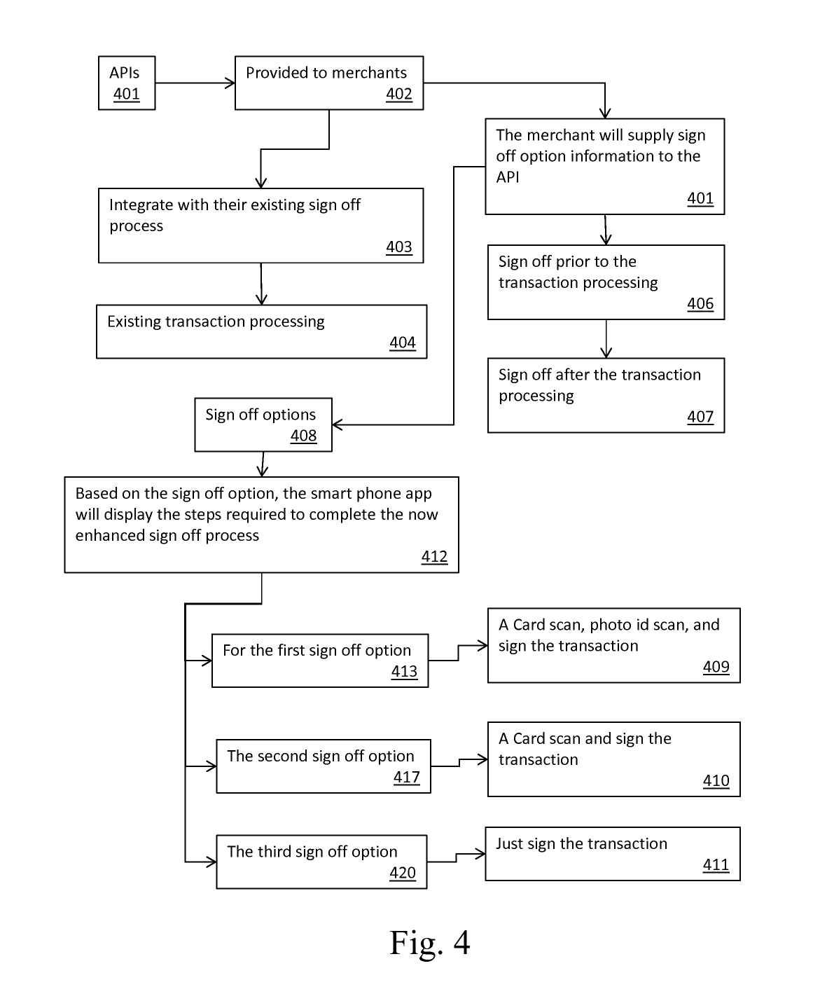

Now referring to FIG. 4 to implement the present invention, APIs 401 are provided to merchants 402 to integrate with their existing sign off process 403 with their existing transaction processing 404. The merchant 402 will supply sign off option information 408 to the API 401. Merchants 402 can sign off either prior to the transaction processing 406 or after the transaction processing 407. Sign off options 408 include: a card scan, photo id scan, and sign the transaction 409; a Card scan and sign the transaction 410; and a just sign the transaction option 411.

Based on the sign off option 408, the smart phone app will display the steps required to complete the now enhanced sign off process 412. For the first sign off option 413, the user will have to first scan the credit card, the second step will be to scan the photo id, and the third step will be to sign the transaction 409. For the second sign off option 417, the user has to scan the credit card and sign the transaction 410. For the third sign off option 420, the user has to just sign the transaction 411.

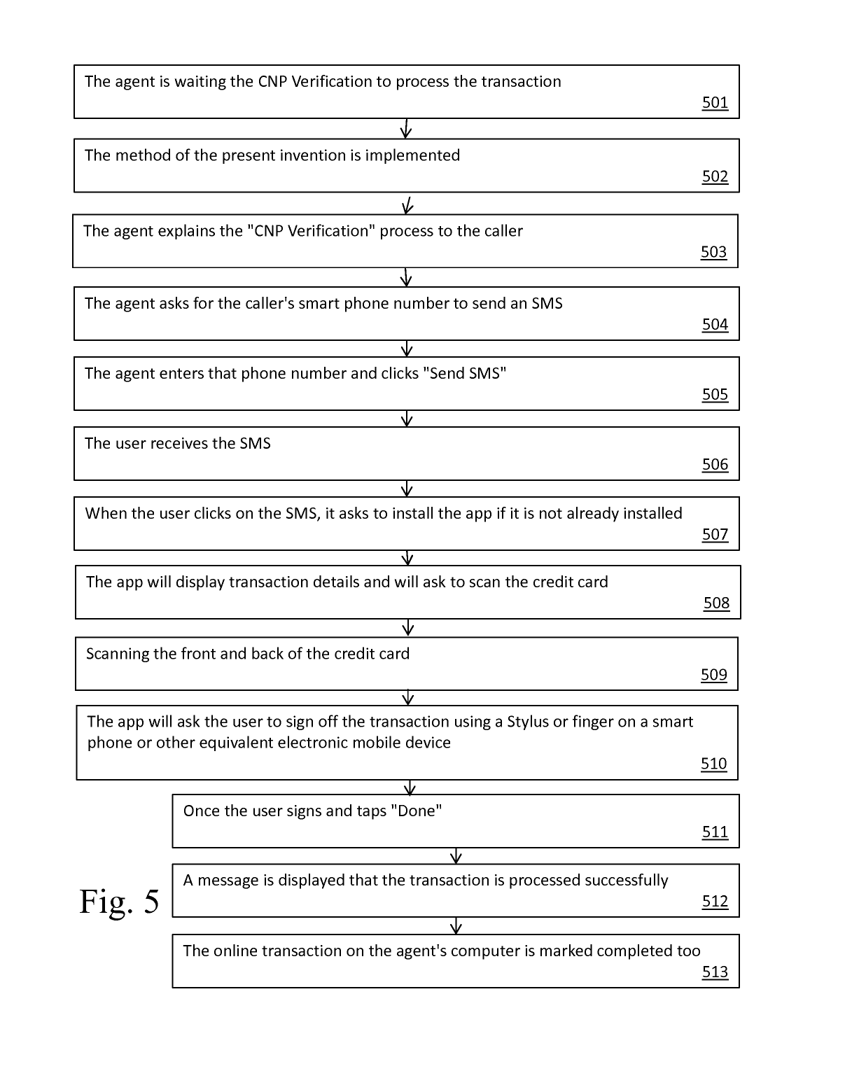

Now referring to FIG. 5, the method illustrated only applies to the second sign off option 417 where the user has to scan the credit card 414 and sign the transaction 416. In this embodiment, a card not present (CNP) transaction is being executed over a phone verbally between a presumed card holder and a merchant. In this embodiment, a User calls a merchants phone number or chats online to make one or more purchases through a call center agent or through the company agent using a credit card or debit card.

Now referring to FIG. 5, in this embodiment, the agent is waiting the CNP Verification to process the transaction 501 and at this point the method of the present invention is implemented 502. In a next step, the agent explains the “CNP Verification” process to the caller 503. The agent asks for the caller's smart phone number to send an SMS 504. The agent enters that phone number and clicks “Send SMS” 505. The user receives the SMS 506. When the user clicks on the SMS 507, it asks to install the app if it is not already installed 507, and the app will display transaction details 508 and will ask to scan the credit card 509. At the end of the process, the app will ask the user to sign off the transaction using a Stylus or finger on a smart phone or other equivalent electronic mobile device 510 to complete the transaction. Once the user signs and taps “Done” 511, a message is displayed that the transaction is processed successfully 512. At this time, the online transaction on the agent's computer is marked completed too 513.

In another embodiment of the present invention is applied to card not present (CNP) transactions where a User places the order and makes payment using credit card over a computer network.

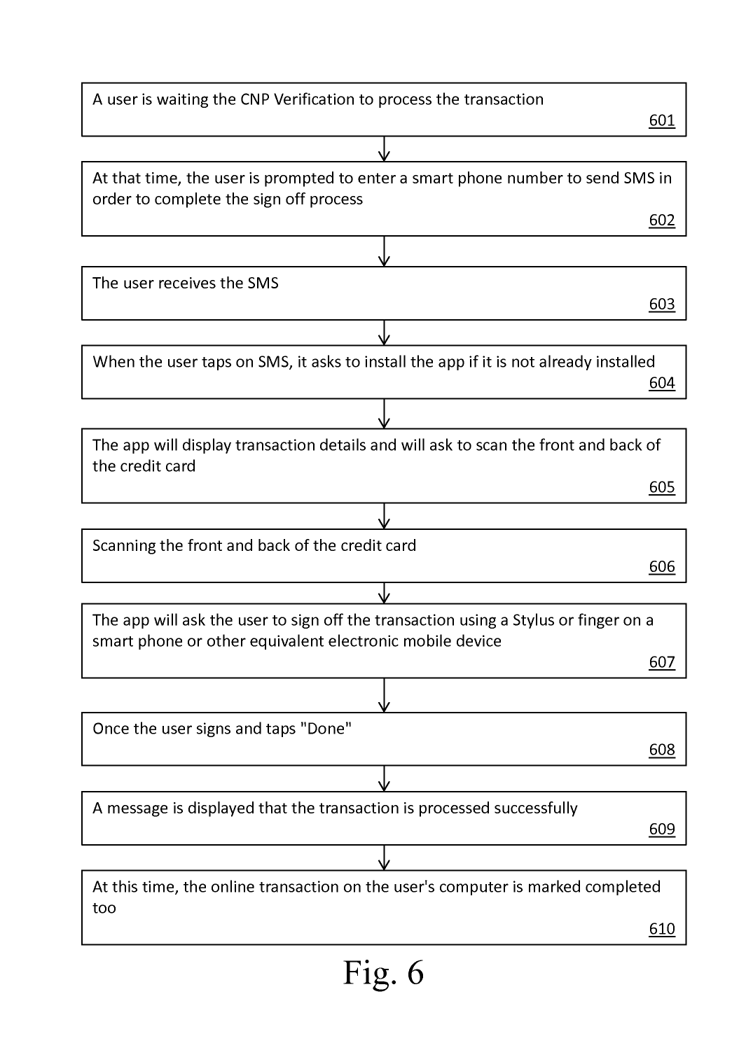

In a first application show in FIG. 6, a user is waiting the CNP Verification to process the transaction 601. At that time, the user is prompted to enter a smart phone number to send SMS in order to complete the sign off process 602. The user receives the SMS 603. When the user taps on SMS, it asks to install the app if it is not already installed 604, and the app will display transaction details and will ask to scan the front and back of the credit card 605. After scanning the front and back of the credit card 606, the app will ask the user to sign off the transaction using Stylus or finger on smart phone or other equivalent electronic mobile device 607. Once the user signs and taps “Done” 608, a message is displayed that the transaction is processed successfully 609. At this time, the online transaction on the user's computer is marked completed too 610.

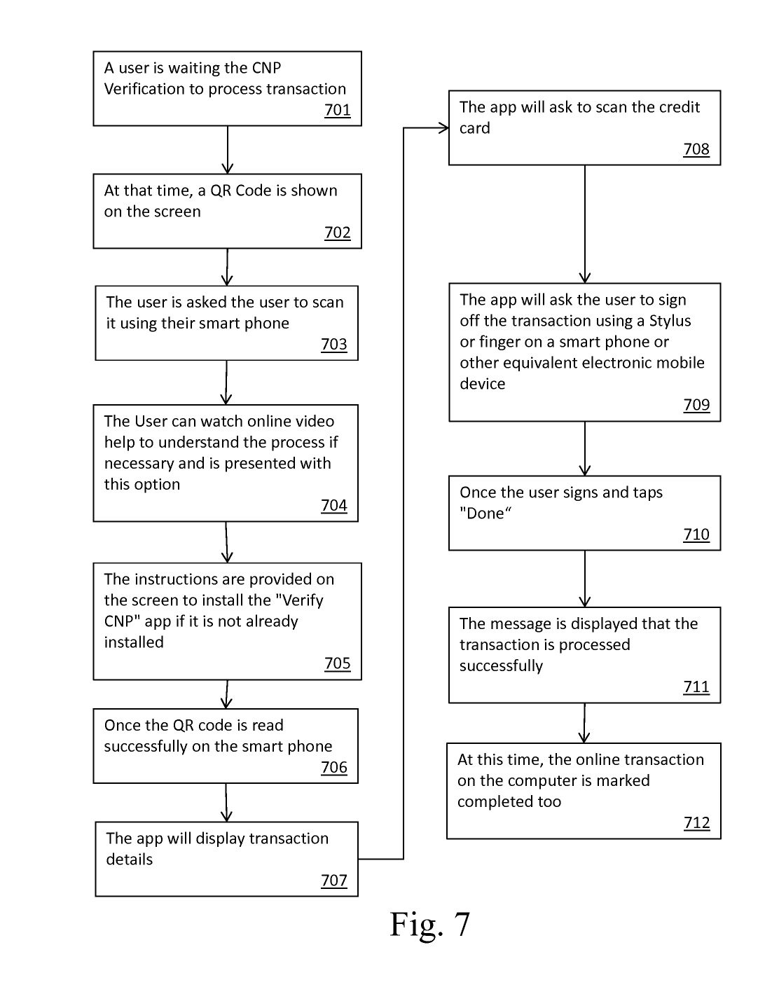

In a second application show in FIG. 7, a user is waiting the CNP Verification to process transaction 701. At that time, a QR Code is shown on the screen 702 and the user is asked the user to scan it using their smart phone 703. The User can watch online video help to understand the process if necessary and is presented with this option 704. The instructions are provided on the screen to install the “Verify CNP” app if it is not already installed 705. Once the QR code is read successfully on the smart phone 706, the app will display transaction details 707 and will ask to scan the credit card 708. Once the credit card is scanned 708, the app will ask the user to sign on the smart phone or other equivalent electronic mobile device 709. Once the user signs and taps “Done” 710, a message is displayed that the transaction is processed successfully 711. At this time, the online transaction on the computer is marked completed too 712.

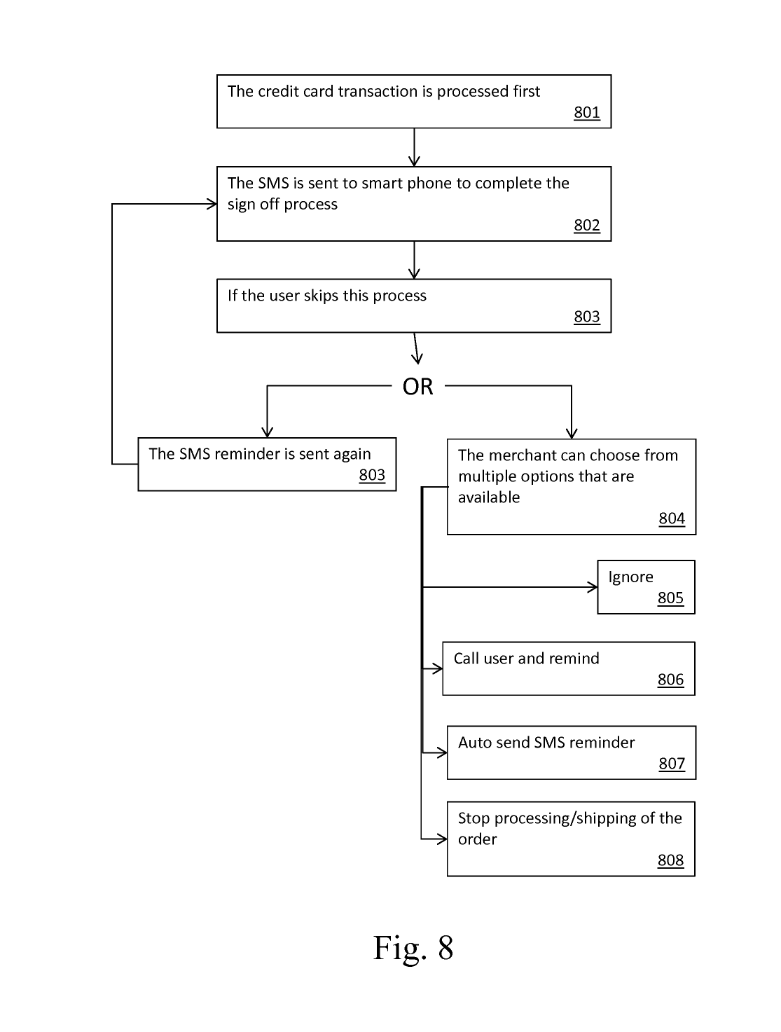

In a third application show in FIG. 8, the method is the same as the second option, but the credit card transaction is processed first 801. Then, the SMS is sent to smart phone to complete the sign off process 802. If the user skips this process 803, the SMS reminder is sent again 803 or the merchant can choose from multiple options that are available 804: ignore 805, call user and remind 806, auto send SMS reminder 807, and stop processing/shipping of the order 808.

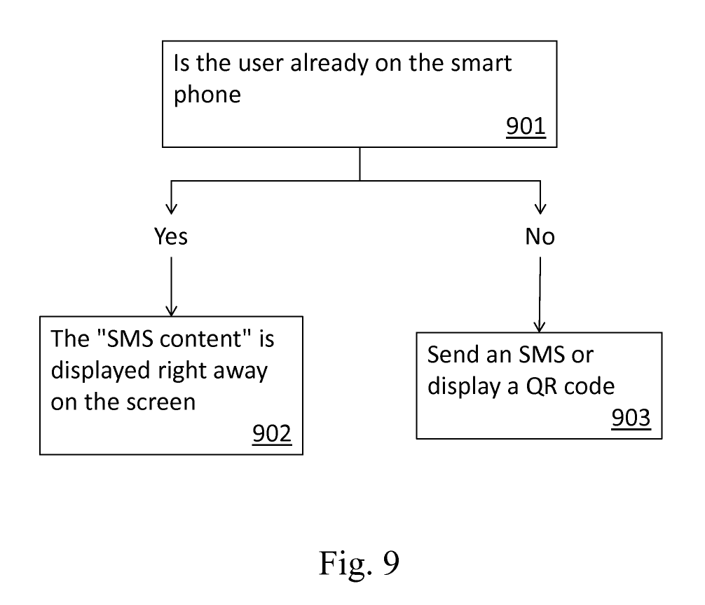

In a fourth application show in FIG. 9, if the user is already on the smart phone 901, the “SMS content” is displayed right away on the screen 902 rather than sending an SMS or displaying a QR code.

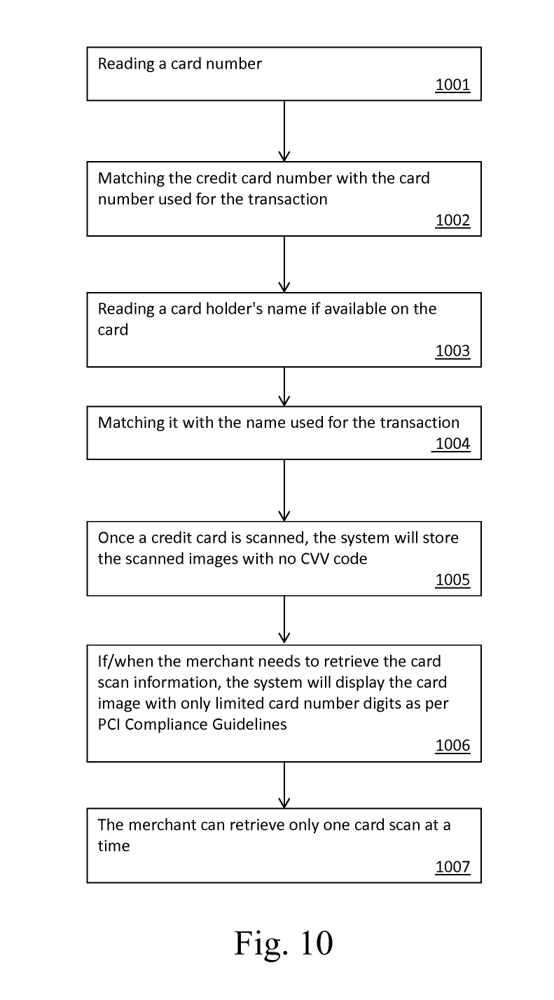

Now referring to FIG. 10, the present invention teaches a method and the technology to scan credit cards and provides features to hide the CVV, if/when present on a credit card. The present invention reads a card number first 1001 and then matches the credit card number with the card number used for the transaction 1002. Additionally, the method provides for reading a card holder's name if available on the card 1003 and matching it with the name used for the transaction 1004. In situations where gift cards are used that do not have a person's name, the name verification step will be an optional feature for the merchant. Once a credit card is scanned, the system will store the scanned images with no CVV code 1005. If/when the merchant needs to retrieve the card scan information, the system will display the card image with only limited card number digits as per PCI Compliance Guidelines 1006. Additionally, the merchant can retrieve only one card scan at a time 1007.

Currently the technology exists to scan photo ids, but there is no technology teaching the reading of a photo id's name and matching it with the name used for the transaction. Additionally, there are challenges because of spelling errors, missing/abbreviated middle name, etc. that must be overcome where the application of a simple scanner and OCR technology would not produce, repeatable and accurate results on a consistent basis.

The system 1 is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The system 1 can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method of providing secured credit card transactions during card not present (CNP) transactions by using non-transitory computer-readable medium capable of execution by a mobile device, the method comprising:
providing APIs to merchants;
integrating the APIs with a merchant's existing sign off process;
integrating the APIs with a merchant's existing transaction processing;
the merchant supplying sign off option information to the API;
receiving card details for payment;
processing the card and transaction information;
requesting an authorization from a merchant bank;
submitting the authorization request to a credit card network;
sending the request to the card issuer;
verifying the card's legitimacy;
approving or declining the transaction by the card issuer;
forwarding the card issuer's authorization response to the merchant bank;
forwarding the response from the merchant bank to the merchant;
receiving the authorization response by the merchant;
providing two-way handover to perform CNP Verification;
performing CNP Verification based on merchant options;
setting security measures in storing information; and
completing the transaction.

2. The method of claim 1, further comprising the step of using Address Verification Service (AVS).

3. The method of claim 1, further comprising the step of using Card Verification Value 2 (CVV2).

4. The method of claim 1, further comprising the steps of
asking the customer for the card expiration date; and
including the expiration date in the authorization request.

5. The method of claim 1, further comprising the steps of a clearing and settlement process.

6. The method of claim 5, wherein the clearing and settlement process further comprises the steps of
depositing the transaction receipt with the merchant bank by the merchant;
crediting the merchant's account by the merchant bank;
submitting the transaction to the card network for settlement;
facilitating settlement by the credit card network;
paying the merchant bank; and
debiting the card issuer account.

7. The method of claim 6, further comprising the steps of
posting the transaction to the cardholder account by the card issuer; and
sending the monthly statement to the cardholder.

8. The method of claim 1, further comprising the steps of
providing one or more additional security steps on a need basis during the transaction processing.

9. The method of claim 1, further comprising the steps of
merchants can sign off either prior to the transaction processing or after the transaction processing; and
sign off options include: a card scan, photo id scan, and sign the transaction; a Card scan and sign the transaction; and a just sign the transaction option.

10. The method of claim 9, further comprising the steps of
based on the sign off option, the smart phone app will display the steps required to complete the now enhanced sign off process.

11. The method of claim 10, wherein for the first sign off option, the user will
scan the credit card,
scan the photo id, and
sign the transaction.

12. The method of claim 10, wherein for the second sign off option, the user will
scan the credit card, and
sign the transaction.

13. The method of claim 10, wherein for the third sign off option, the user will
sign the transaction.

14. The method of claim 12, wherein for the second sign off option,
a user calls a merchants phone number or chats online to make one or more purchases through a call center agent; or
a user calls a merchants phone number or chat online to make one or more purchases through the company agent using a credit card.

15. The method of claim 10, wherein
a user is waiting the CNP Verification to process the transaction;
the user is prompted to enter a smart phone number to send SMS in order to complete the sign off process;
the user receives the SMS;
when the user taps on SMS, it asks to install the app if it is not already installed;
the app will display transaction details;
the app will ask to scan the front and back of the credit card;
after scanning the front and back of the credit card, the app will ask the user to sign off the transaction using a stylus or finger on smart phone;
once the user signs and taps “Done”, a message is displayed that the transaction is processed successfully; and
the online transaction on the user's computer is marked completed too.

16. The method of claim 10, wherein
a user is waiting the CNP Verification to process transaction;
a QR Code is shown on the screen;
the user is asked to scan it using their mobile device;
the user can watch online video help to understand the process if necessary and is presented with this option;
the instructions are provided on the screen to install the “Verify CNP” app if it is not already installed;
once the QR code is read successfully on the smart phone,
the app will display transaction details;
the app will ask to scan the credit card;
once the credit card is scanned, the app will ask the user to sign off the transaction using a stylus or finger on smart phone;
once the user signs and taps “Done”, a message is displayed that the transaction is processed successfully; and
the online transaction on the computer is marked completed too.

17. The method of claim 10, wherein
the credit card transaction is processed first;
the SMS is sent to smart phone to complete the sign off process; and
if the user skips this process, the SMS reminder is sent again or the merchant can choose from multiple options that are available.

18. The method of claim 17, wherein the multiple options available to the merchant if the user skips the SMS are:
ignore,
call user and remind,
auto send SMS reminder, and
stop processing/shipping of the order.

19. The method of claim 16, wherein
if the user is already on the smart phone, the “SMS content” is display right away on the screen rather than sending an SMS or displaying a QR code.

20. The method of claim 10, further comprising the steps of
providing features to hide the CVV, if/when present on a scanned credit card;
reading a card number;
matching the credit card number with the card number used for the transaction;
reading a card holder's name if available on the card;
matching the card holder's name that was read with the name used for the transaction; and
once a credit card is scanned, the system will only display the limited card number digits as per PCI Compliance Guidelines and no CVV code.

21. The method of claim 20, wherein if/when the merchant needs to retrieve the card scan information,
the merchant can retrieve only one card scan at a time; and
the system will only display the limited card number digits as per PCI Compliance Guidelines and no CVV code.

22. The method of claim 20, wherein
in situations where gift cards are used that do not have a person's name, the name verification step will be an optional feature for the merchant.
